(19) United States
(12) Patent Application Publication
(10) Pub. No.: US 2026/0034991 A1
(43) Pub. Date: Feb. 5, 2026

(54) VEHICLE CONTROLLER, METHOD, AND COMPUTER PROGRAM FOR VEHICLE CONTROL

(71) Applicants: TOYOTA JIDOSHA KABUSHIKI KAISHA, Toyota-shi (JP); DENSO CORPORATION, Kariya-city (JP)

(72) Inventor: Osamu KANAI, Nagoya-shi (JP)

(73) Assignees: TOYOTA JIDOSHA KABUSHIKI KAISHA, Toyota-shi (JP); DENSO CORPORATION, Kariya-city (JP)

(21) Appl. No.: 19/186,892

(22) Filed: Apr. 23, 2025

(30) Foreign Application Priority Data
Jul. 30, 2024 (JP) 2024-123542

(51) Int. Cl. B60W 30/182; B60W 40/08; B60W 50/12; G06V 20/59

(52) U.S. Cl. CPC B60W 30/182; B60W 40/08; B60W 50/12; G06V 20/597; B60W 2040/0827; B60W 2420/403; B60W 2540/01; B60W 2540/229

(57) ABSTRACT

A vehicle controller includes a processor configured to: determine, when operation for terminating execution of emergency stop mode in which a vehicle makes an emergency stop in response to sensing of abnormality of a driver of the vehicle is performed during execution of the emergency stop mode, who is an operator of the operation, based on an interior sensor signal generated by a vehicle interior sensor for sensing conditions in the interior of the vehicle, continue control of the vehicle according to the emergency stop mode when the operator is an occupant of the vehicle other than the driver, and terminate execution of the emergency stop mode when the operator is the driver.

### FIELD

The present invention relates to a vehicle controller, a method, and a computer program for vehicle control that controls travel of a vehicle when abnormality has occurred in a driver.

### BACKGROUND

A technique has been researched to enable a passenger-seat or rear-seat passenger's operation by an emergency evacuation device that provides emergency evacuation assistance for stopping a vehicle at a safe position without driving operation of a driver of the vehicle (see Japanese Unexamined Patent Publication No. 2014-19301). The emergency evacuation device enables movement operation of the vehicle by vehicle-mounted operation means or display means, which enables screen input operation, being operated after the start of the emergency evacuation assistance or the stop of the vehicle by the emergency evacuation assistance.

### SUMMARY

Safety of a vehicle may not be ensured if an occupant other than a driver operates the vehicle to interrupt control for making an emergency stop of the vehicle while the vehicle is controlled to make an emergency stop in response to detection of the driver's abnormality.

It is an object of the present invention to provide a vehicle controller that can ensure safety of the vehicle when the driver's abnormality is sensed.

According to an embodiment, a vehicle controller is provided. The vehicle controller includes a processor configured to: determine, when operation for terminating execution of emergency stop mode in which a vehicle makes an emergency stop in response to sensing of abnormality of a driver of the vehicle is performed during execution of the emergency stop mode, who is an operator of the operation, based on an interior sensor signal generated by a vehicle interior sensor for sensing conditions in the interior of the vehicle, continue control of the vehicle according to the emergency stop mode when the operator is an occupant of the vehicle other than the driver, and terminate execution of the emergency stop mode when the operator is the driver.

In an embodiment, when the operator is an occupant of the vehicle other than the driver, the processor cancels a control command corresponding to the operation for terminating execution of the emergency stop mode and given to the vehicle.

In an embodiment, the processor is further configured to determine whether the driver's state has recovered to normal during execution of the emergency stop mode. When the driver's state has recovered to normal at the time of the operation for terminating execution of the emergency stop mode, the processor terminates execution of the emergency stop mode even if the operator is an occupant of the vehicle other than the driver.

According to another embodiment, a method for vehicle control is provided. The method includes determining, when operation for terminating execution of emergency stop mode in which a vehicle makes an emergency stop in response to sensing of abnormality of a driver of the vehicle is performed during execution of the emergency stop mode, who is an operator of the operation, based on an interior sensor signal generated by a vehicle interior sensor for sensing conditions in the interior of the vehicle; continuing control of the vehicle according to the emergency stop mode when the operator is an occupant of the vehicle other than the driver; and terminating execution of the emergency stop mode when the operator is the driver.

According to still another embodiment, a non-transitory recording medium that stores a computer program for vehicle control is provided. The computer program includes instructions causing a processor mounted on a vehicle to execute a process including determining, when operation for terminating execution of emergency stop mode in which the vehicle makes an emergency stop in response to sensing of abnormality of a driver of the vehicle is performed during execution of the emergency stop mode, who is an operator of the operation, based on an interior sensor signal generated by a vehicle interior sensor for sensing conditions in the interior of the vehicle; continuing control of the vehicle according to the emergency stop mode when the operator is an occupant of the vehicle other than the driver; and terminating execution of the emergency stop mode when the operator is the driver.

The vehicle controller of the present disclosure has an advantageous effect of being able to ensure safety of the vehicle when the driver's abnormality is sensed.

### BRIEF DESCRIPTION OF DRAWINGS

FIG. 1 schematically illustrates the configuration of a vehicle control system equipped with a vehicle controller.

FIG. 2 illustrates the hardware configuration of an electronic control unit, which is an embodiment of the vehicle controller.

FIG. 3 is a functional block diagram of a processor of the electronic control unit, related to a vehicle control process.

FIG. 4A is a diagram for explaining the relationship between the operator of termination operation performed during execution of emergency stop mode and whether emergency stop mode can be continued.

FIG. 4B is a diagram for explaining the relationship between the operator of termination operation performed during execution of emergency stop mode and whether emergency stop mode can be continued.

FIG. 5 is an operation flowchart of the vehicle control process.

### DESCRIPTION OF EMBODIMENTS

A vehicle controller, a method for vehicle control executed by the vehicle controller, and a computer program for vehicle control will now be described with reference to the attached drawings. The vehicle controller has the function of an “emergency driving stop system (EDSS).” When abnormality that makes it difficult for a driver to keep driving a vehicle is detected, the vehicle controller controls the vehicle according to emergency stop mode for automatically stopping the vehicle. The vehicle controller determines who is an operator of operation for terminating execution of emergency stop mode when the operation is performed during execution of the emergency stop mode, and continues control of the vehicle according to the emergency stop mode when the operator is an occupant of the vehicle other than the driver. In this way, the vehicle controller prevents execution of emergency stop mode from being terminated while the driver's state is abnormal.

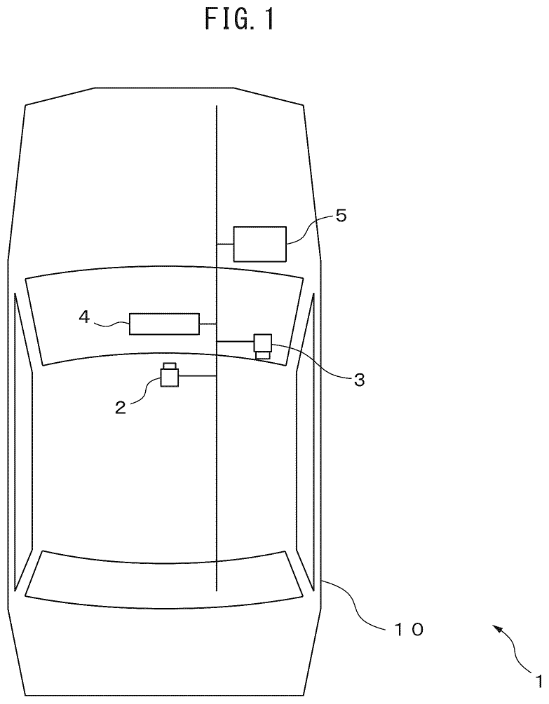

FIG. 1 schematically illustrates the configuration of a vehicle control system equipped with the vehicle controller. In the present embodiment, the vehicle control system 1, which is mounted on a vehicle 10 and controls the vehicle 10, includes a vehicle exterior camera 2, a driver monitoring camera 3, a notification device 4, and an electronic control unit (ECU) 5, which is an example of the vehicle controller. The vehicle exterior camera 2, the driver monitoring camera 3, and the notification device 4 are communicably connected to the ECU 5. The vehicle 10 may also include a range sensor (not illustrated) that measures the distances from the vehicle 10 to objects around the vehicle 10, such as LiDAR or radar. The vehicle 10 may further include a position determining device (not illustrated) for determining the position of the vehicle 10 by a satellite positioning system, such as a GPS receiver. The vehicle 10 may further include a wireless communication terminal (not illustrated) for wireless communication with another device.

The vehicle exterior camera 2, which is an example of an exterior image capturing unit, is mounted on the vehicle 10 so as to face a predetermined region in the vicinity of the vehicle 10, such as a region in front of the vehicle 10. The vehicle 10 may include multiple vehicle exterior cameras taking pictures in different orientations or having different focal lengths. Every predetermined capturing period, the vehicle exterior camera 2 takes a picture of the predetermined region to generate an image representing the predetermined region (hereafter a “vehicle exterior image”) and outputs the generated vehicle exterior image to the ECU 5.

The driver monitoring camera 3 is an example of the vehicle interior sensor for sensing conditions in the interior of the vehicle. The driver monitoring camera 3 is mounted near the top of the windshield or near an instrument panel and oriented to the driver so that the head of the driver sitting on the driver's seat of the vehicle 10 and a hand operating a device that is operated to interrupt emergency stop mode are included in the region to be captured by the camera. The driver monitoring camera 3 may include a light source, such as an infrared LED. Every predetermined capturing period, the driver monitoring camera 3 takes a picture of the region to be captured to generate an image including the driver (hereafter a “driver image”) and outputs the generated driver image to the ECU 5.

The notification device 4 is provided in the interior of the vehicle 10, and gives predetermined notification to the occupants of the vehicle 10 by light, voice, vibration, or display of text or an image. To achieve this, the notification device 4 includes, for example, at least one of a speaker, a light source, a vibrator, or a display. When a notification signal indicating predetermined notification to the occupants of the vehicle 10 is received from the ECU 5, the notification device 4 gives the notification to the occupants by a voice from the speaker, lighting up or blinking the light source, vibration of the vibrator, or displaying a notification message or an icon on the display.

The ECU 5 functions as an EDSS. More specifically, when abnormality that makes it impossible for the driver to keep driving the vehicle 10 is detected, the ECU 5 controls the vehicle 10 to make an emergency stop of the vehicle 10.

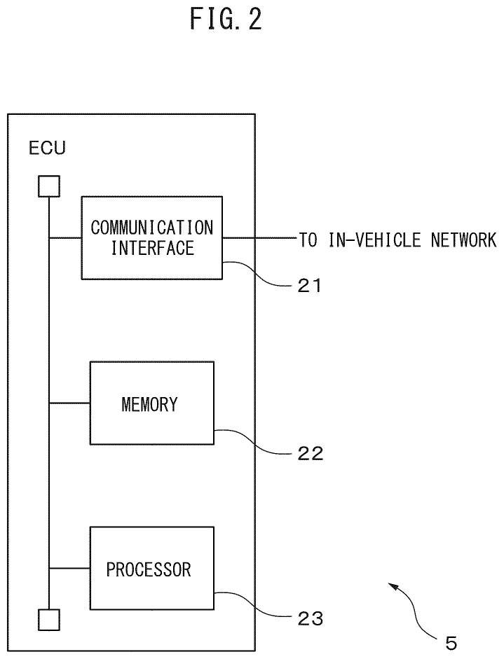

FIG. 2 illustrates the hardware configuration of the ECU 5. As illustrated in FIG. 2, the ECU 5 includes a communication interface 21, a memory 22, and a processor 23. The communication interface 21, the memory 22, and the processor 23 may be configured as separate circuits or a single integrated circuit.

The communication interface 21 includes an interface circuit for connecting the ECU 5 to another device inside the vehicle. The communication interface 21 passes a vehicle exterior image received from the vehicle exterior camera 2 and a driver image received from the driver monitoring camera 3 to the processor 23. Further, the communication interface 21 outputs a notification signal received from the processor 23 to the notification device 4. In addition, the communication interface 21 outputs a control signal for controlling the vehicle 10.

The memory 22, which is an example of a storage unit, includes, for example, volatile and nonvolatile semiconductor memories. The memory 22 stores various types of data used in a vehicle control process executed by the processor 23 of the ECU 5. For example, the memory 22 stores parameters of the vehicle exterior camera 2, such as its mounted position, orientation, and focal length. The memory 22 also stores various parameters used for detecting the driver's abnormality from driver images. In addition, the memory 22 temporarily stores vehicle exterior images received from the vehicle exterior camera 2 and driver images received from the driver monitoring camera 3.

The processor 23 includes one or more central processing units (CPUs) and a peripheral circuit thereof. The processor 23 may further include another operating circuit, such as a logic-arithmetic unit, an arithmetic unit, or a graphics processing unit. The processor 23 executes a vehicle control process on the vehicle 10.

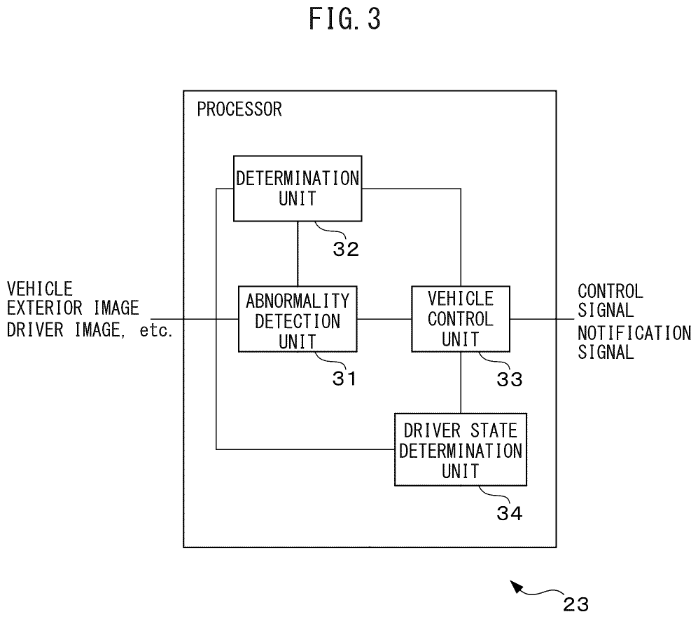

FIG. 3 is a functional block diagram of the processor 23, related to the vehicle control process. The processor 23 includes an abnormality detection unit 31, a determination unit 32, a vehicle control unit 33, and a driver state determination unit 34. These units included in the processor 23 are, for example, functional modules implemented by a computer program executed by the processor 23, or may be dedicated operating circuits provided in the processor 23.

When abnormality that makes it impossible to keep driving the vehicle 10 has occurred in the driver, the abnormality detection unit 31 detects the abnormality. In the following, the fact that abnormality that makes it impossible to keep driving the vehicle 10 has occurred in the driver will be referred to simply as “abnormality has occurred in the driver,” for convenience of description.

For example, the abnormality detection unit 31 determines the driver's sleepiness level at predetermined intervals, based on a series of driver images obtained in a most recent certain period. When the driver's sleepiness level is such that the driver cannot watch ahead of the vehicle 10, the abnormality detection unit 31 determines that abnormality has occurred in the driver. To achieve this, the abnormality detection unit 31 detects the driver's looking direction and the degrees of opening of the eyes and the mouth (hereafter referred to as the “eye opening level” and the “mouth opening level,” respectively) of the driver from each of the series of driver images obtained in the most recent certain period. The abnormality detection unit 31 then determines the driver's sleepiness level, based on the detected looking direction, eye opening level, and mouth opening level.

The abnormality detection unit 31 detects a region representing the driver's face (hereafter a “face region”) in a driver image, for example, by inputting the driver image into a classifier that has been trained to detect a driver's face from an image. Such a classifier is configured, for example, as a deep neural network (DNN) having architecture of a convolutional neural network (CNN) type, e.g., Single Shot MultiBox Detector (SSD) or Faster R-CNN. Alternatively, such a classifier may be configured as a DNN having an attention mechanism, e.g., Vision transformer, or a classifier based on another machine learning technique, e.g., an AdaBoost classifier. Such a classifier is pre-trained in accordance with a predetermined training technique, such as backpropagation, with a large number of training images representing a human face. The abnormality detection unit 31 detects the driver's eyes and mouth from the face region of the driver image. To this end, the abnormality detection unit 31 applies, for example, an edge detection filter, such as a Sobel filter, to detect edge pixels in the face region. The abnormality detection unit 31 then detects lines of edge pixels extending in a substantially horizontal direction, and detects, for each of the left and right eyes, such two lines separated vertically in an area in the face region where the eye is supposed to lie, as the upper and lower eyelids of the eye. Similarly, the abnormality detection unit 31 detects a sub-region defined by such two lines separated vertically in an area in the face region where the mouth is supposed to lie, as the driver's mouth. The abnormality detection unit 31 may detect the upper and lower eyelids of the driver's left and right eyes from a driver image in accordance with another technique for detecting upper and lower eyelids from an image. Similarly, the abnormality detection unit 31 may detect the driver's mouth from a driver image in accordance with another technique for detecting a mouth from an image.

For each driver image, the abnormality detection unit 31 estimates the driver's eye opening level, based on the distances between the upper and lower eyelids of the left and right eyes. For example, the abnormality detection unit 31 determines the average of the distances between the upper and lower eyelids of the left and right eyes as the eye opening level. The abnormality detection unit 31 may estimate the eye opening level in accordance with another technique for calculating an eye opening level from upper and lower eyelids in an image. The abnormality detection unit 31 calculates the interval between maxima of the eye opening level from time-varying changes in the eye opening level in the series of driver images as the duration of the driver's single blink. The abnormality detection unit 31 then counts the number of blinks in the most recent certain period, and calculates the average of intervals between blinks as the period of a blink. In addition, the abnormality detection unit 31 calculates, for example, the ratio of the vertical length of the mouth to the horizontal length thereof for each driver image in the most recent certain period, and calculates the average of the ratios as the driver's mouth opening level. The abnormality detection unit 31 may calculate the driver's mouth opening level in accordance with another technique for calculating a mouth opening level from a region representing a mouth in an image.

In addition, the abnormality detection unit 31 detects the driver's looking direction from each driver image. For example, in at least one of the driver's left and right eyes represented in each driver image, the abnormality detection unit 31 detects a corneal reflection image of a light source and the centroid of the pupil (hereafter simply the “pupillary centroid”) from the region defined by the upper and lower eyelids (hereafter the “eye region”). A corneal reflection image of a light source is also referred to as a Purkinje image. Specifically, the abnormality detection unit 31 detects a Purkinje image, for example, by template matching of the eye region with templates of a Purkinje image. Similarly, the abnormality detection unit 31 detects the pupil by template matching of the eye region with templates of a pupil, and determines the centroid of the region representing the detected pupil as the pupillary centroid. The abnormality detection unit 31 may detect a Purkinje image and the pupillary centroid in accordance with another technique for detecting them from an eye region. The abnormality detection unit 31 then calculates the direction and distance from the Purkinje image to the pupillary centroid, and refers to a table representing the relationship between the direction and distance and a driver's looking direction, thereby detecting the driver's looking direction. Such a table may be prestored in the memory 22. The abnormality detection unit 31 determines the amount of change in the looking direction for each pair of successive driver images in the most recent certain period, and divides the average of the amounts of change by the interval of acquisition of the driver images, thereby calculating the rate of change in the looking direction.

The abnormality detection unit 31 determines the driver's sleepiness level, based on at least one of the period and frequency of blinks, the mouth opening level, and the rate of change in the looking direction, and determines that abnormality has occurred in the driver when the sleepiness level is such that the driver cannot watch ahead of the vehicle 10. For example, the abnormality detection unit 31 determines that abnormality has occurred in the driver, in the case where the number of blinks in the most recent certain period is greater than or equal to a predetermined number, the period of a blink is longer than a predetermined time threshold, and the mouth opening level is higher than a predetermined opening level.

The abnormality detection unit 31 may determine whether abnormality has occurred in the driver, based on another index indicating the driver's state. For example, when the driver's face or eyes have not been detected from driver images for a predetermined period, the abnormality detection unit 31 may determine that abnormality has occurred in the driver. Alternatively, when the driver's eyes have been closed for a predetermined period, the abnormality detection unit 31 may determine that abnormality has occurred in the driver. In this case, when the eye opening level is less than or equal to an eye closure determination threshold corresponding to the state in which eyes are closed, the abnormality detection unit 31 determines that the driver's eyes are closed. When a microphone (not illustrated) is provided in the vehicle interior, the abnormality detection unit 31 may detect a particular abnormal sound made by the driver (e.g., a snoring sound) from a voice signal generated by the microphone and representing a voice in the vehicle interior. The abnormality detection unit 31 may then determine that abnormality has occurred in the driver, when a particular abnormal sound made by the driver is detected. The abnormality detection unit 31 detects a particular abnormal sound made by the driver in accordance with one of techniques for detecting the abnormal sound from a voice signal. The microphone is another example of the vehicle interior sensor. A voice signal generated by the microphone is another example of the interior sensor signal.

When it is determined that abnormality has occurred in the driver, the abnormality detection unit 31 instructs the determination unit 32 and the vehicle control unit 33 to activate the EDSS function, i.e., to apply emergency stop mode. When it is determined that no abnormality has occurred in the driver, the abnormality detection unit 31 need not activate the EDSS function.

The determination unit 32 determines who is an operator of operation for terminating execution of emergency stop mode (hereafter simply “termination operation”) when the operation is performed during execution of the emergency stop mode. In the present embodiment, the period during which emergency stop mode is executed includes a period from a phase of announcing the start of execution of control for making an emergency stop of the vehicle 10 according to emergency stop mode until an aid phase of asking for aid to the outside after the stop of the vehicle 10.

Types of termination operation whose operator is to be determined includes operation that an occupant of the vehicle 10 other than the driver can perform, e.g., at least one of the following: steering operation, hazard light turning-off operation, shift lever operation, electric parking brake (EPB) releasing operation, parking brake operation, IG-OFF operation, and door opening operation. When a switch for operation for terminating emergency stop mode is provided where it can be operated by an occupant other than the driver (e.g., on the instrument panel), operation of the switch is also included in the types of operation to be determined. Operation that is difficult for an occupant other than the driver to perform, e.g., operation of the brake pedal or the accelerator pedal need not be necessarily included in the types of operation to be determined.

When notified by a device subjected to termination operation that the termination operation has been performed, the determination unit 32 inputs multiple driver images obtained in a predetermined period (e.g., one second to several seconds) including the timing of the termination operation sequentially in the order of generation of these driver images into a classifier that has been trained to determine the operator. The classifier then outputs the result of determination of the operator. Such a classifier is configured as a DNN having a recursive structure, such as a recurrent neural network (RNN) or LSTM.

Alternatively, the classifier may be pre-trained to detect an occupant's body part used for termination operation, such as an occupant's hand or finger, from a driver image. Such a classifier is configured as a DNN having a CNN or an attention mechanism. Alternatively, such a classifier may be configured as one based on a machine learning algorithm other than a DNN, such as an adaBoost classifier. In this case, the determination unit 32 identifies a driver image generated at the timing of the termination operation or before or after the timing as a driver image at the time of the termination operation. The determination unit 32 then inputs the driver image at the time of the termination operation into the classifier to detect individual occupants represented in the driver image. The determination unit 32 then determines the occupant closest to the device subjected to the termination operation of the detected individual occupants as the occupant who has performed the termination operation. Device position information indicating the positions of individual devices to be subjected to termination operation in driver images may be prestored in the memory 22. The determination unit 32 identifies the position in the driver image of the device subjected to the termination operation, by referring to the device that is the source of notification that termination operation is performed and the device position information. For example, when the device subjected to the termination operation is hazard lights, the occupant closest to the switch of the hazard lights in the driver image of the occupants detected from the driver image at the time of the termination operation is determined as the one who is the operator of the termination operation.

Alternatively, the determination unit 32 may determine the operator of the termination operation, based on an interior sensor signal from a vehicle interior sensor other than the driver monitoring camera 3. For example, when a weight sensor or a touch sensor is provided for each seat inside the vehicle, sensor signals from these sensors may be used for determining the operator. In this case, the weight sensor or the touch sensor of each seat is another example of the vehicle interior sensor. The determination unit 32 may determine that the operator of the termination operation is an occupant other than the driver, when a sensor signal from a weight sensor provided in the passenger seat or the rear seat indicates that the weight is greater than or equal to a predetermined sensing threshold immediately before the timing of the termination operation and only less than the sensing threshold at the timing of the termination operation. Similarly, the determination unit 32 may determine that the operator of the termination operation is an occupant other than the driver, when a sensor signal from a touch sensor provided in the passenger seat or the rear seat indicates that something touches the seat immediately before the timing of the termination operation, and that nothing touches the seat at the timing of the termination operation. This is because a device for termination operation is provided near the driver, so that an occupant other than the driver is supposed to leave his/her seat when performing termination operation. When there is no change in weight indicated by sensor signals from the weight sensors provided in the seats or in the presence or absence of contact indicated by sensor signals from the touch sensors provided in the seats before and after the termination operation, the determination unit 32 determines that the operator of the termination operation is the driver.

The determination unit 32 outputs the result of determination about the operator of the performed termination operation to the vehicle control unit 33.

When notified that the driver's abnormality is detected, the vehicle control unit 33 controls the vehicle 10 according to emergency stop mode. More specifically, when notified that the driver's abnormality is detected, the vehicle control unit 33 decelerates the vehicle 10 to a predetermined low speed, and thereafter controls the vehicle 10 to stop at a target stopping position.

First, in a control announcement phase, the vehicle control unit 33 informs the surroundings of the vehicle 10 that the vehicle 10 will make an emergency stop. To achieve this, the vehicle control unit 33 turns on the hazard lights, and notifies the occupants of the vehicle 10 that emergency stop mode will be executed, via the notification device 4.

After a predetermined period (e.g., several seconds) in the control announcement phase, the vehicle control unit 33 decelerates the vehicle 10 and stops the vehicle 10 at a target stopping position in a driving intervention phase. For example, the vehicle control unit 33 sets the target stopping position on a road shoulder of a road section being traveled by the vehicle 10. Alternatively, the vehicle control unit 33 may determine whether there is an evacuation space on the road section being traveled by the vehicle 10 within a predetermined distance of the current position of the vehicle 10, by referring to map information and the current position of the vehicle 10 determined by a position determining device (not illustrated). When there is such an evacuation space, the vehicle control unit 33 may set the evacuation space as the target stopping position.

The vehicle control unit 33 generates a planned trajectory of the vehicle 10 from the current position of the vehicle 10 to the target stopping position. The planned trajectory is represented, for example, as a set of target positions of the vehicle 10 at respective times during travel of the vehicle 10 on the trajectory. The vehicle control unit 33 controls components of the vehicle 10 so that the vehicle 10 travels along the planned trajectory.

The vehicle control unit 33 decelerates the vehicle 10 to a low speed, and controls the vehicle 10 so that the vehicle travels to the target stopping position at the low speed. When starting decelerating the vehicle 10, the vehicle control unit 33 also honks the horn. In addition, the vehicle control unit 33 detects objects in the way of the vehicle 10, such as other vehicles around the vehicle 10, and lane lines from each of time-series vehicle exterior images obtained by the vehicle exterior camera 2. The vehicle control unit 33 detects such objects and lane lines by inputting vehicle exterior images into a classifier that has been trained to detect such objects and lane lines. The classifier is configured, for example, as a DNN having a CNN or an attention mechanism. Alternatively, when the vehicle 10 includes a range sensor, such as a LiDAR sensor, the vehicle control unit 33 may detect objects around the vehicle 10, based on a ranging signal obtained by the range sensor.

The vehicle control unit 33 generates a planned trajectory so that the vehicle 10 will not collide with any of the objects around the vehicle 10. To achieve this, the vehicle control unit 33 tracks the objects around the vehicle 10 detected, for example, from time-series vehicle exterior images, and estimates predicted trajectories of the respective objects to a predetermined time ahead from the trajectories obtained from the result of tracking. Specifically, the vehicle control unit 33 applies a predetermined tracking process, such as Byte Track, to the series of vehicle exterior images to track the objects.

For each object being tracked, the vehicle control unit 33 executes viewpoint transformation, using parameters such as the position at which the vehicle exterior camera 2 is mounted on the vehicle 10, thereby transforming the image coordinates of the object into coordinates in an aerial image (“aerial image coordinates”). To this end, the vehicle control unit 33 can estimate the position of the detected object at the time of acquisition of each image, using the position of the vehicle 10 measured by the position determining device, the travel direction of the vehicle 10 measured by an orientation sensor (not illustrated), an estimated distance to the detected object, and the direction from the vehicle 10 to the object at the time of acquisition of each image. The bottom position of an object region representing the detected object is supposed to correspond to the position at which the object is on the road surface. Thus the vehicle control unit 33 can determine the estimated distance to the detected object, based on the bottom position of the object region in the vehicle exterior image and parameters of the vehicle exterior camera 2, such as the orientation and the height of the mounted position. Alternatively, the vehicle control unit 33 may determine the distance measured by the range sensor in the direction corresponding to the object region representing the detected object as the estimated distance to the detected object. For each object being tracked, the vehicle control unit 33 can estimate the trajectory of the object by arranging the estimated positions in chronological order. The vehicle control unit 33 can then estimate the predicted trajectories of the objects being tracked to a predetermined time ahead by executing a prediction process with, for example, a Kalman filter or a particle filter, based on the trajectories of the objects in a most recent predetermined period.

The vehicle control unit 33 generates a planned trajectory, based on the predicted trajectories of the objects being tracked, so that predicted distances between the vehicle 10 and the objects will be greater than or equal to a predetermined distance until the predetermined time ahead, and that a lane change to the target stopping position will be completed as necessary.

Upon setting a planned trajectory, the vehicle control unit 33 controls components of the vehicle 10 so that the vehicle 10 travels along the planned trajectory. For example, the vehicle control unit 33 determines the deceleration of the vehicle 10 according to the planned trajectory and the current speed of the vehicle 10 measured by a vehicle speed sensor (not illustrated), and controls a power train and a brake device so as to decelerate at the determined deceleration.

When the direction of the vehicle 10 is changed in order for the vehicle 10 to travel along the planned trajectory, the vehicle control unit 33 determines the steering angle of the vehicle 10 according to the planned trajectory. The vehicle control unit 33 then outputs a control signal depending on the steering angle to an actuator (not illustrated) that controls the steering wheel of the vehicle 10. When the vehicle 10 makes a lane change, the vehicle control unit 33 turns on a direction indicator on the side of the destination lane.

When the vehicle 10 is stopped, the vehicle control unit 33 releases the locks of doors and continues honking the horn in the aid phase. The vehicle control unit 33 may send information that abnormality has occurred in the driver, via a wireless communication terminal (not illustrated) mounted on the vehicle 10.

Further, when termination operation is performed during execution of emergency stop mode, the vehicle control unit 33 refers to the result of determination of the operator of the termination operation by the determination unit 32. When the operator is the driver, the vehicle control unit 33 terminates execution of emergency stop mode. When terminating execution of emergency stop mode, the vehicle control unit 33 notifies the occupants of the vehicle 10 that execution of emergency stop mode will be terminated, via the notification device 4. Thereafter, the vehicle control unit 33 controls travel of the vehicle 10 according to the driver's driving operation.

When the operator of the termination operation is an occupant other than the driver, the vehicle control unit 33 continues control of the vehicle 10 according to emergency stop mode. This prevents execution of emergency stop mode from being terminated when the driver cannot drive the vehicle 10. Further, the vehicle control unit 33 generates a notification signal indicating that the termination operation is canceled, i.e., that control of the vehicle 10 according to emergency stop mode continues, and outputs the notification signal to the notification device 4. In this way, the vehicle control unit 33 notifies the occupants of the vehicle 10 that the termination operation is canceled, via the notification device 4.

When the operator of the termination operation is an occupant other than the driver, the vehicle control unit 33 may cancel a control command corresponding to the termination operation and given to the vehicle 10. For example, when the termination operation is EPB releasing operation, the vehicle control unit 33 continues control of the vehicle 10 according to emergency stop mode and does not release the EPB. When the termination operation is hazard light turning-off operation, the vehicle control unit 33 continues control of the vehicle 10 according to emergency stop mode and does not turn off the hazard lights. In this way, the control command corresponding to the termination operation and given to the vehicle 10 is also canceled to enable the vehicle control unit 33 to prevent motion of the vehicle from becoming unstable by operation of an occupant other than the driver.

When it is determined by the driver state determination unit 34 that the driver has recovered to a normal state in which the driver can drive the vehicle 10 at the time of termination operation, the vehicle control unit 33 may terminate execution of emergency stop mode even if the operator of the termination operation is an occupant other than the driver. In this case, since the driver's state is normal, the driver can take over driving control of the vehicle 10 from the vehicle control unit 33 even if an occupant other than the driver has performed termination operation. This eliminates the need for the vehicle control unit 33 making an emergency stop of the vehicle 10.

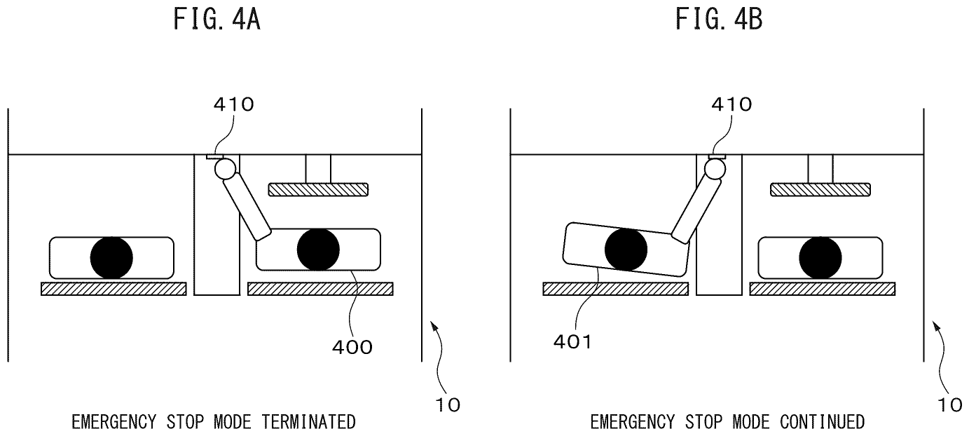

FIGS. 4A and 4B are diagrams for explaining the relationship between the operator of termination operation performed during execution of emergency stop mode and whether emergency stop mode can be continued.

In the example illustrated in FIG. 4A, a driver 400 touches a switch 410 for terminating execution of emergency stop mode to perform termination operation. This terminates execution of emergency stop mode, and transfers control of the vehicle 10 from the ECU 5 to the driver 400. In the example illustrated in FIG. 4B, a passenger 401 sitting on the passenger seat touches a switch 410 for terminating execution of emergency stop mode to perform termination operation. This results in continuation of control of the vehicle 10 according to emergency stop mode, and thus prevents control of the vehicle 10 from being transferred to the driver while it is difficult for the driver to drive the vehicle 10 normally.

The driver state determination unit 34 determines whether the driver has recovered to a normal state in which the driver can drive the vehicle 10, during execution of control of the vehicle 10 according to emergency stop mode. To achieve this, the driver state determination unit 34 executes processing similar to that executed by the abnormality detection unit 31 during execution of control of the vehicle 10 according to emergency stop mode. When none of the conditions for determining that the driver's state is abnormal is met, the driver state determination unit 34 determines that the driver's state has recovered to normal.

The driver state determination unit 34 may determine whether the driver's state has recovered to normal, based on the presence or absence of the driver's response to an action to the driver performed by an occupant other than the driver. For example, the driver state determination unit 34 may analyze a voice collected by one or more microphones (not illustrated) provided in the vehicle 10 to determine whether the driver is responding to a voice of an occupant other than the driver. The driver state determination unit 34 determines that the driver's state has recovered to normal, when the driver is responding; and determines that the driver's state has not recovered to normal, when the driver is not responding. In this example, the driver state determination unit 34 applies a predetermined speaker identification technique to a voice signal representing a collected voice to identify a voice of an occupant other than the driver and a voice of the driver. When the driver has spoken within a predetermined period of a voice of an occupant other than the driver, the driver state determination unit 34 determines that the driver has responded, i.e., that the driver's state has recovered to normal. When the driver has not spoken even after the predetermined period, the driver state determination unit 34 determines that the driver is not responding, i.e., that the driver's state has not recovered to normal. Alternatively, the driver state determination unit 34 may determine the presence or absence of the driver's response, by inputting multiple driver images in the order of generation into a classifier that has been trained to identify whether a driver responds to an action of an occupant other than the driver. When the classifier outputs the result of identification that the driver responds, the driver state determination unit 34 determines that the driver's state has recovered to normal. When the classifier does not output the result of identification that the driver responds, the driver state determination unit 34 determines that the driver's state has not recovered to normal. Such a classifier is configured as a DNN having a recursive structure, such as a RNN or LSTM.

When it is determined that the driver's state has recovered to normal, the driver state determination unit 34 notifies the result of determination to the vehicle control unit 33.

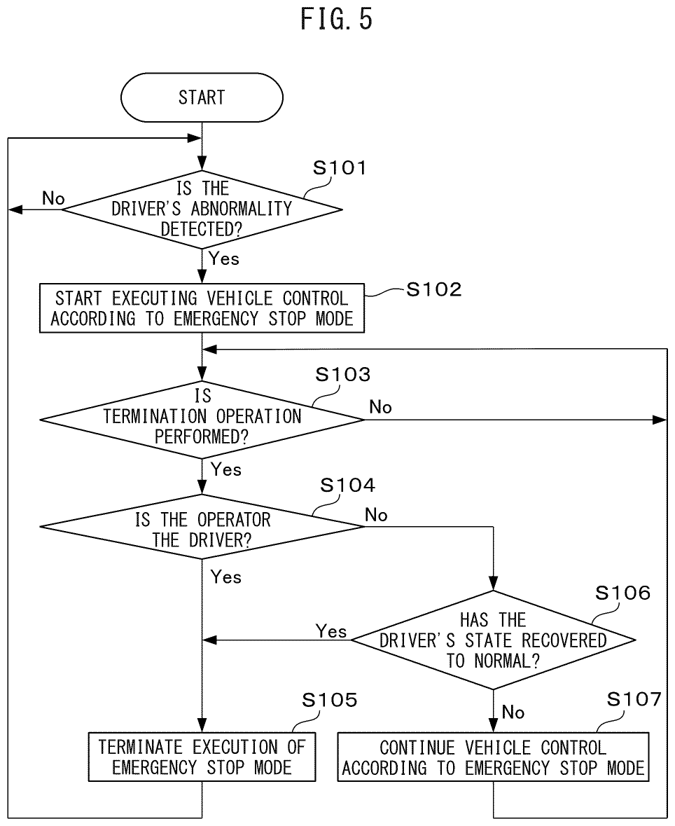

FIG. 5 is an operation flowchart of the vehicle control process executed by the processor 23.

The abnormality detection unit 31 determines whether the driver's abnormality is detected (step S101). When the driver's abnormality is not detected (No in step S101), the processor 23 repeats the processing of step S101.

When the driver's abnormality is detected (Yes in step S101), the vehicle control unit 33 starts control of the vehicle 10 according to emergency stop mode (step S102). Thereafter, the determination unit 32 determines whether termination operation is performed (step S103). When no termination operation is performed (No in step S103), the processor 23 repeats the processing of step S103.

When termination operation is performed (Yes in step S103), the determination unit 32 determines whether the operator of the termination operation is the driver (step S104). When the operator is the driver (Yes in step S104), the vehicle control unit 33 terminates execution of emergency stop mode (step S105). Thereafter, the processor 23 repeats the processing of step S101 and the subsequent steps.

When the operator is an occupant other than the driver (No in step S104), the vehicle control unit 33 determines whether the result of determination by the driver state determination unit 34 that the driver's state has recovered to normal has been received (step S106). When the driver's state has recovered to normal (Yes in step S106), the processor 23 repeats the processing of step S105 and the subsequent steps. When the driver's state has not recovered to normal (No in step S106), the vehicle control unit 33 continues control of the vehicle 10 according to emergency stop mode (step S107). Thereafter, the processor 23 repeats the processing of step S103 and the subsequent steps until processing according to emergency stop mode is finished.

As has been described above, the vehicle controller determines who is an operator of operation for terminating execution of emergency stop mode when the operation is performed during execution of the emergency stop mode, and continues control of the vehicle according to the emergency stop mode when the operator is an occupant of the vehicle other than the driver. In this way, the vehicle controller prevents execution of emergency stop mode from being terminated while the driver's state is abnormal. The vehicle controller can therefore ensure safety of the vehicle when the driver's abnormality is sensed.

According to a modified example, when the operator of termination operation is an occupant other than the driver, the vehicle control unit 33 may continue control of the vehicle 10 according to emergency stop mode, regardless of the driver's state. In this case, the processing of the driver state determination unit 34 may be omitted.

The computer program for achieving the vehicle control process of the above-described embodiment or modified example may be provided in recorded form on a computer-readable portable storage medium.

As described above, those skilled in the art may make various modifications according to embodiments within the scope of the present invention.

What is claimed is:

1. A vehicle controller comprising:
a processor configured to:
determine, when operation for terminating execution of emergency stop mode in which a vehicle makes an emergency stop in response to sensing of abnormality of a driver of the vehicle is performed during execution of the emergency stop mode, who is an operator of the operation, based on an interior sensor signal generated by a vehicle interior sensor for sensing conditions in the interior of the vehicle,
continue control of the vehicle according to the emergency stop mode when the operator is an occupant of the vehicle other than the driver, and
terminate execution of the emergency stop mode when the operator is the driver.

2. The vehicle controller according to claim 1, wherein when the operator is an occupant of the vehicle other than the driver, the processor cancels a control command corresponding to the operation and given to the vehicle.

3. The vehicle controller according to claim 1, wherein the processor is further configured to determine whether the driver's state has recovered to normal during execution of the emergency stop mode, wherein
when the driver's state has recovered to normal at the time of the operation, the processor terminates execution of the emergency stop mode even if the operator is an occupant of the vehicle other than the driver.

4. A method for vehicle control, comprising:
determining, when operation for terminating execution of emergency stop mode in which a vehicle makes an emergency stop in response to sensing of abnormality of a driver of the vehicle is performed during execution of the emergency stop mode, who is an operator of the operation, based on an interior sensor signal generated by a vehicle interior sensor for sensing conditions in the interior of the vehicle;
continuing control of the vehicle according to the emergency stop mode when the operator is an occupant of the vehicle other than the driver; and
terminating execution of the emergency stop mode when the operator is the driver.

5. A non-transitory recording medium that stores a computer program for vehicle control, the computer program causing a processor mounted on a vehicle to execute a process comprising:
determining, when operation for terminating execution of emergency stop mode in which the vehicle makes an emergency stop in response to sensing of abnormality of a driver of the vehicle is performed during execution of the emergency stop mode, who is an operator of the operation, based on an interior sensor signal generated by a vehicle interior sensor for sensing conditions in the interior of the vehicle;
continuing control of the vehicle according to the emergency stop mode when the operator is an occupant of the vehicle other than the driver; and
terminating execution of the emergency stop mode when the operator is the driver.
